(19) United States
(12) Patent Application Publication
(10) Pub. No.: US 2025/0190058 A1
(43) Pub. Date: Jun. 12, 2025

(54) HAND TRACKING IN EXTENDED REALITY ENVIRONMENTS

(71) Applicant: CURIOXR, INC., Gainesville, FL (US)

(72) Inventor: Ethan FIELDMAN, Gainesville, FL (US)

(73) Assignee: CURIOXR, INC., Gainesville, FL (US)

(21) Appl. No.: 19/062,803

(22) Filed: Feb. 25, 2025

Related U.S. Application Data
(63) Continuation of application No. 18/461,422, filed on Sep. 5, 2023.

(51) Int. Cl. G06F 3/01; G06F 3/04845; G06F 3/04847; G06V 40/20

(52) U.S. Cl. CPC G06F 3/017; G06F 3/014; G06F 3/04845; G06F 3/04847; G06V 40/28; G06F 2203/04804

(57) ABSTRACT

A method for receiving a control input from a user in an extended reality (XR) environment by detecting a pointing by a user in the XR environment to a virtual object including a representation of real world physical tool or article of clothing and displaying one or more of a menu, changed attribute, activity or another virtual object in response to identifying the specific physical tool or article of clothing being pointed at by the user in extended reality.

### CROSS-REFERENCE TO RELATED APPLICATIONS

This application claims the benefit of priority of U.S. application Ser. No. 18/461,422 filed Sep. 5, 2023, which is incorporated by reference herein in its entirety.

### BACKGROUND OF THE INVENTION

Extended reality (XR) environments, i.e., environments created by immersive technologies that merge physical and virtual worlds, such as augmented reality (AR), virtual reality (VR), and mixed reality (MR) and the like, have grown more realistic and immersive as VR headsets, augmented reality devices and applications, processor speeds, data storage and data transfer technologies have continued to improve. However, unlike conventional physical reality, electronic XR environments present more opportunities for persons to collaborate and share information, including in work and education fields, in ways that are not possible in the physical constraints of the real-world.

U.S. Pat. No. 11,531,448, incorporated herein by reference in its entirety, describes tracking user's hands and inputs in XR environments as an improvement over using hardware controls. However, there remains a need to provide users with more intuitive gesturing to interact with an XR environment and with visual feedback so that a user knows that their hand, hands and/or combinations of body parts are detected by the respective XR platform to provide controls, inputs, and interactions to the XR environment.

### SUMMARY OF THE INVENTION

To address these needs, embodiments of the invention provide an improved method and system for users in XR environments, including VR environments such as in the Oculus/Meta Quest platform by Oculus VR (Irvine, CA) (parent company Meta), to control, provide commands and interact with an XR environment through hand, and other body parts, with tracking by an XR device camera(s) and providing visual feedback to a user, such as showing a hand having different colors, patterns, outlining, and the like, that corresponds to a tracking state and available functionality for the hand or body part.

In further embodiments, combinations of a hand, hands and/or combinations of body parts, are tracked to determine if a user is pointing at a body part, other avatar, digital object, and the like in the XR environment, and the XR platform will activate certain interactive functionalities based on the target being pointed at. For example, a user in an XR environment may be detected as pointing at their mouth and the XR platform may render a VR microphone for the user to use, or display a menu of mouth-related choices for tools and objects available to the user for interactive use in the XR environment.

It will be appreciated that the systems and methods, including related displays, user interfaces, controls, and functionalities, disclosed herein may be similarly implemented on other XR platforms with other XR SDKs and software development tools known to XR developers.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic block diagram of XR device in an embodiment of the invention.

FIG. 2 is a block diagram of an XR system platform in an embodiment of the invention.

FIG. 3 is a schematic diagram illustrating a combination of hand tracking gestures detectable by an XR system platform that includes a first hand displaying Shaka sign and a second opposite hand displaying two-finger gesture in an embodiment of the invention.

FIG. 4 is a schematic diagram illustrating a combination of hand tracking gestures detectable by an XR system platform that includes a first hand pointing at a second opposite hand with palm gesture in an embodiment of the invention.

FIG. 5 is a schematic diagram illustrating a combination of hand tracking gestures detectable by an XR system platform that includes a first hand pointing at a facial body part, e.g., a mouth, in an embodiment of the invention.

FIG. 6 is a schematic diagram illustrating a combination of hand tracking gestures detectable by an XR system platform that includes a first hand with virtual pointing object pointing at a facial body part, e.g., a mouth, in an embodiment of the invention.

FIG. 7 is a schematic diagram illustrating a combination of hand tracking gestures detectable by an XR system platform that includes a first hand pointing at a second hand with a palm open gesture that triggers display of an interactive color selection wheel for an associated virtual object in an embodiment of the invention.

FIG. 8 is a schematic diagram illustrating a combination of hand tracking gestures detectable by an XR system platform that includes a first hand pointing at a second hand with a writing instrument that triggers functionality to be applied to the writing instrument in the XR environment in an embodiment of the invention.

FIG. 9 is a schematic diagram illustrating a combination of hand tracking gestures detectable by an XR system platform that includes a first hand gesturing for a virtual marker with a writing instrument pose and second hand with a palm up pose for displaying an interactive color wheel to select the color of the virtual marker in the XR environment in an embodiment of the invention.

FIG. 10 is a schematic diagram illustrating a three-tier hierarchal selection dial with three rotatable and concentric dial levels used to select multiple writing instruments and attributes for a chosen instrument in an embodiment of the invention utilizing described hand tracking methods and combination gestures detectable by an XR system platform.

### DETAILED DESCRIPTION

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

In various embodiments, methods and systems of the invention are preferably implemented through development tools for the Oculus/Meta Quest platform (Oculus Platform SDK) by Oculus VR (Irvine, Calif.) (parent company Meta). It will be appreciated that the systems and methods, including related displays, user interfaces, controls, and functionalities, disclosed herein may be similarly implemented on other VR or extended reality (XR) platforms with other VR SDKs and software development tools known to VR developers.

### Computer-Implemented System

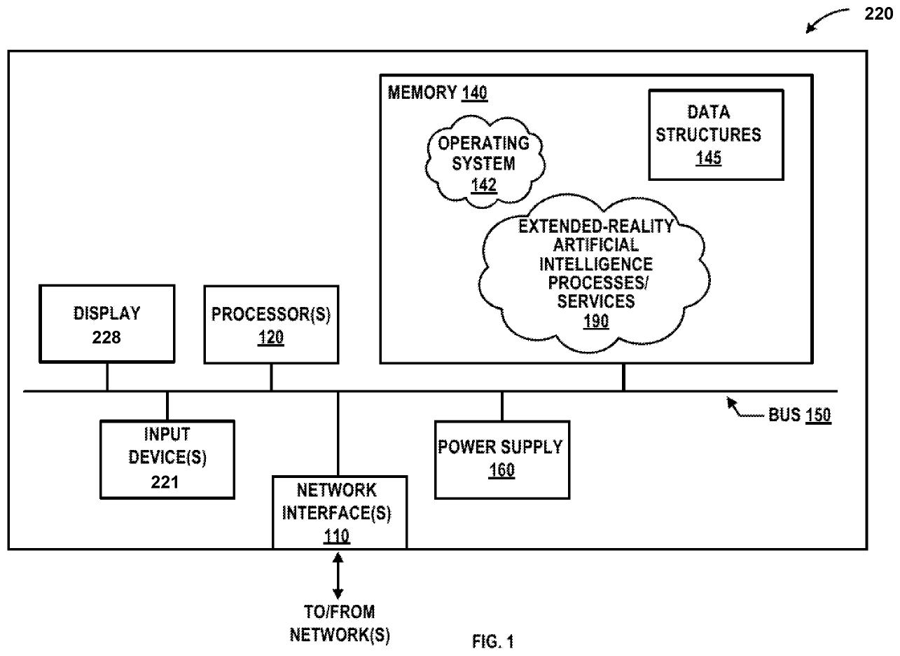

FIG. 1 is a schematic block diagram of an example XR device 220, such as wearable XR headset, that may be used with one or more embodiments described herein.

XR device 220 comprises one or more network interfaces 110 (e.g., wired, wireless, PLC, etc.), at least one processor 120, and a memory 140 interconnected by a system bus 150, as well as a power supply 160 (e.g., battery, plug-in adapter, solar power, etc.). XR device 220 can further include a display 228 for display of the XR learning environment, where display 228 can include a virtual reality display of a VR headset. Further, XR device 220 can include input device(s) 221, which can include audio input devices and orientation/inertial measurement devices. For tracking of body parts, such as hands, faces, arms and legs, held physical objects, and the like, input devices include cameras (such as integrated with an XR headset device or external cameras) and/or wearable movement tracking electronic devices, such as electronic gloves, electronic straps and bands, and other electronic wearables. XR devices of the invention may connect to one or more computing systems via wired (e.g., high speed Ethernet connection) or wireless connections (e.g., high speed wireless connections), such that computer processing, particular processing requiring significant processing and power capabilities, can be carried out remotely from the display of the XR device 220 and need not be self-contained on the XR device 220.

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, XR device 220 may have limited memory or no memory (e.g., no memory for storage other than for programs/processes operating on the device and associated caches). Memory 140 can include instructions executable by the processor 120 that, when executed by the processor 120, cause the processor 120 to implement aspects of the system and the methods outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes XR device 220 by, inter alia, invoking operations in support of software processes and/or services executing on the device. These software processes and/or services may include Extended Reality (XR) artificial intelligence processes/services 190, which can include methods and/or implementations of standalone processes and/or modules providing functionality described herein. While XR artificial intelligence (AI) processes/services 190 are illustrated in centralized memory 140, alternative embodiments provide for the processes/services to be operated as programmed software within the network interfaces 110, such as a component of a MAC layer, and/or as part of a distributed computing network environment. It will be appreciated that AI processes include the combination of sets of data with processing algorithms enable the AI process to learn from patterns and features in the data being analyzed, problem being solved, or answer being retrieved. Preferably each time an AI process processes data, it tests and measures its own performance and develops additional expertise for the requested task.

In various embodiments AI processes/services 190 may create requested digital object images via image generating AI system, such as Dall-E or Dall-E 2 (see https://openai.com/product/dall-e-2 incorporated herein by preference) or other similar image generation systems and other synthetic media. In other embodiments, an AI process/service 190 might retrieve a requested digital object image from one or more local databases, centralized databases, cloud-based databases such as Internet databases, or decentralized databases. Some further examples of connected AI processes may include ChatGPT™ by OpenAI™ and Wolfram™ tools for AI and the like that the XR system of the invention can use for text and speech-based outputs.

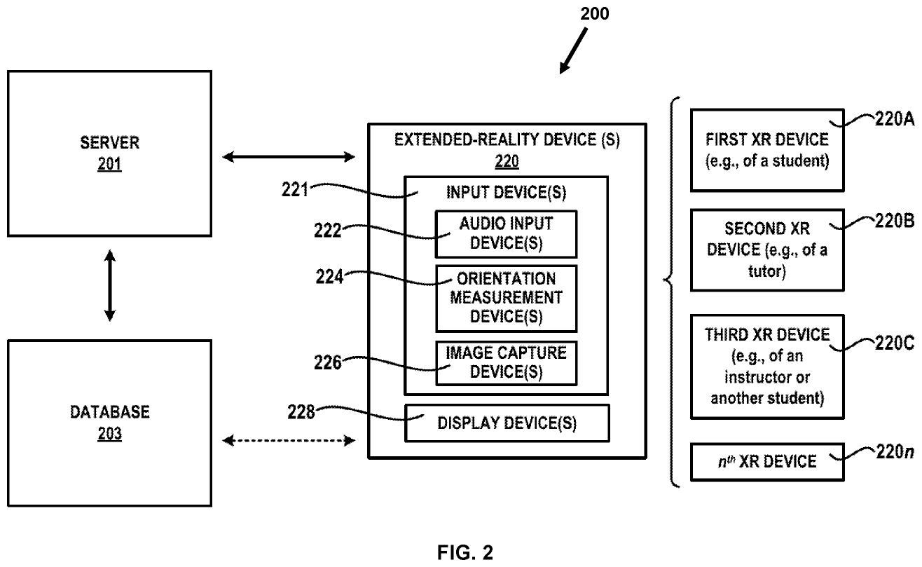

Referring to FIG. 2, an XR system (hereinafter, “system 200”) for implementation of the XR learning environment, including an XR server 201 accessible by a plurality of XR devices 220 (e.g., a first XR device 220A of a first user such as a student, a second XR device 220B of a second user such as a tutor, a third XR device 220C of a third user such as an instructor . . . an nth XR device 220n belonging to another user, etc.) and another suitable computing devices with which a user can participate in the XR learning environment. The system includes a database 203 communicatively coupled to the XR server 201.

XR devices 220 includes components as input devices 221, such as audio input devices 222, orientation measurement devices 224, image capture devices 226 and XR display devices 228, such as headset display devices.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions.

### Combination Hand Gestures

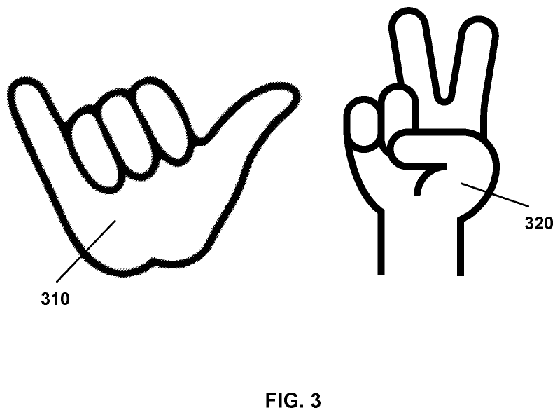

In embodiments of the invention, a user's hands in an XR environment can be tracked such that a gesture from a first hand is detected by XR system 200 together with another gesture from the second hand that complements the first hand gesture. While prior art hand tracking techniques may track two hands together as a “combined gesture” to activate a function in an XR environment, the present invention provides a different mechanism of XR hand tracking where one hand indicates a desired function, and the second hand provides a related, complementary or sub-selection that further specifies the desired function of the first hand. Referring to FIG. 3, as an example, a user can hold up a Shaka sign with a first hand 310 in the XR environment. The Shaka sign in a particular environment, e.g., educational environment, can be assigned to trigger the system upon detection of the first hand Shaka sign that the user is calling for a tool to be presented for use by the user. The user then can simultaneously or subsequently hold up their second hand 320 with a certain number of fingers to signify a choice of a tool that the user wants presented, e.g., one finger is choice “1” for a virtual marker, two fingers is choice “2” for a virtual scissors, three fingers is choice “3” for a virtual calculator, etc. In embodiments where both hands are recognized simultaneously as a gesture, it will be appreciated that the combination of hands together is forming a “combined” gesture that provides together one or more functions to be triggered by the XR system.

In other embodiments, a first hand gesture could be tracked to determine that a user would like to change an attribute of a virtual object being used or nearby the user in the XR environment. A second hand gesture is also being tracked from the second hand being tracked and upon detection will specify the attribute type or activate presentation of a selection mechanism, such as virtual dial, drop down menu, and like virtual menus, so that the user can define the attribute of the object attribute specified by the gesture of the first hand. As an example, a user might be holding a virtual marker in the XR environment and want to change the color of the marker. The user could hold up a palm of the first hand not holding the marker to signify a color change is desired to the “thing” in the other hand, i.e. a marker in such example, and the hand holding the marker could be tracked as a virtual dial that can be rotated with a color selection, e.g. color wheel, where rotating the user's second hand holding the marker is tracked and provides and interface for the user to select a color for the marker. A significant variety of detectable combination gestures and selection of attributes can be programmed to be recognized an XR system of the invention such that one hand is tracked to indicate a genus of objects, attributes, functions, and the like, is desired by the user in the XR environment and the second hand is tracked for complementary selection or defining of a species of the genus such as type, color, number, size, length, and the like.

In some embodiments, a user could adjust axis of rotation for a virtual object by using hand gestures. For example, a user playing an airplane video game might point with one hand at the opposite hand and gesture with the opposite hand being pointed at with a flat palm down. The user can then rotate the flat palm hand to adjust pitch and roll of the airplane in the video game. In other embodiments, other virtual objects can be selected and similar two-handed changing of axis of rotation provided as input by the user in the XR environment.

In other embodiments, different hand gestures could be used to change the speed, height, length, size, volume and other features and attributes of nearby virtual objects, objects being held, and activities or virtual environmental conditions of the XR environment. In some embodiment is a stationary gesture is recognized for providing the control input to specify the attribute. In other embodiments, motion of a hand or other body part in combination with the gesture can be used to select the attribute or attribute value.

In further embodiments, hand gestures may be programmed to be recognized with different functionalities or having the same function based on whether the front or back of the hand is recognized as facing away from or toward the user, i.e., mirror images of gestures can be programmed in the XR system to be recognized as the same gesture or as two different gestures. Further, in embodiments of the invention, turning a hand at different angles could be recognized as different gestures providing different functionality depending on how the hand is rotated and/or certain fingers are extended, curled, opened, closed or in certain proximity (or have certain pointing angles) relative to the other hand, body parts or nearby objects,

### Pointing to Body Parts

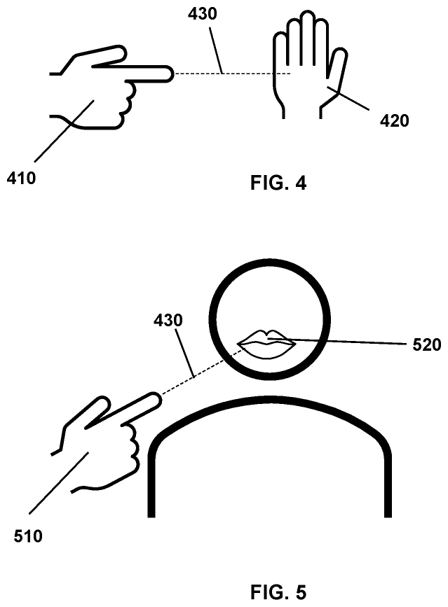

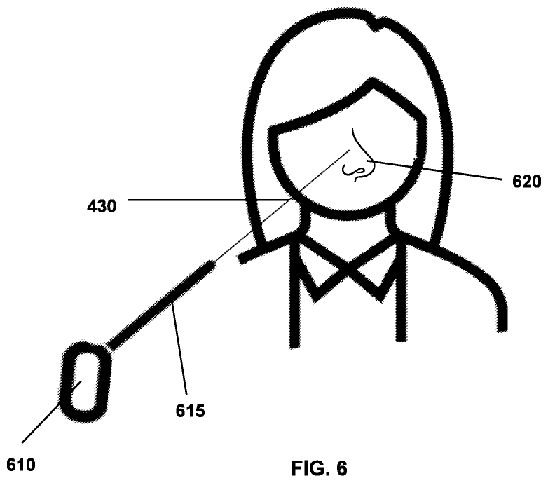

In embodiments of the invention, one or more cameras, electronic gloves, wearable body trackers or similar body movement tracking devices (each a “body tracking device”) are input devices to an XR hardware display device and system. A body tracking device monitors body movements of the user using an extended reality hardware display device to whom the extended reality environment is being displayed to automatically detect when the user is pointing with a first hand 410, 510 (FIGS. 4 and 5) or a first virtual object 615 in the extended reality environment being represented in the first hand 610 to a body part of the user such as nose 620 (FIG. 6) or second hand 420 (FIG. 4) or mouth 520 (FIG. 5). In certain embodiments, known raycasting techniques in immersive environments are used to determine when a raycast line 430 or plane from a first hand (FIGS. 4 and 5) or virtual object in the hand (FIG. 6) intersects with a body part of the user, such as another hand (FIG. 4), mouth (FIG. 5) and nose (FIG. 6). It will be appreciated that when a hand or virtual object in the hand is pointing but not at any detectable body part or other virtual object (e.g. there is pointing without raycasting creating intersection of a raycast line from, for example, a finger of a hand or virtual pointing object in a hand, with a body part or other virtual object) that the XR system remains an “unactive” or “default” state that does not present any functionality as compared to when functionalities would be activated if the user is detected to be pointing at a body part or virtual object.

In some embodiments, eye tracking can be used as an alternative to pointing with a user's hand. For example, the XR platform will determine the location of the user's gaze, similar to detecting a pointing direction and location/coordinates described herein relative to a hand and raycast but in an eye tracking embodiment, and detect if a body part or other virtual object is being looked at and selected by the user for interactivity.

The XR system determines a type of the body part being pointed to by the user from among a plurality of different recognizable body parts that are stored in a database of the XR system or by using Artificial Intelligence (AI) processes to discern what body part is being pointed at. In some embodiments, a determination of the type of body part being pointed at could also be made by the type of body part being programmed or saved in memory of the XR system so that when, for instance, raycasting is detected to intersect the body part and the type of body part is programmed to be recognized at such XR coordinates where the body part is intersected After the system identifies the type of body part that is detected from the pointing, at least one of a menu, second virtual object, changed body part attribute or activity is displayed to the user based on the type of the body part being pointed to by the user.

In some embodiments the body movements of the user are monitored with one or more cameras communicatively coupled to the extended reality hardware display device. The cameras may be integrated to coupled to the XR display device or may be external cameras.

In some embodiments the body movements of the user are monitored with one or more electronic gloves or wearable tracking devices communicatively coupled to the extended reality hardware display device.

Referring to FIG. 4, in some embodiments the body part being pointed at is a second hand, and the XR system further detects a gesture of the second hand, such as an upward open palm, that triggers display of the at least one of the menu, second virtual object, changed body part attribute or activity to the user based on the gesture.

Referring to FIGS. 5 and 6, in some embodiment the body part being pointed at is a facial body part, such as a mouth, nose, ear, eye and the like, and the system further detects a facial expression or gesture from the facial body part that triggers display of the at least one of the menu, second virtual object, changed body part attribute or activity to the user based on the facial expression or gesture. For example, if the sure points to a mouth, this may be processed, based on programming of the system, as a request for a virtual microphone to be displayed for the user to use. If the user points to their nose, this may trigger a display of “CONGRATULATIONS—THAT'S RIGHT” and/or with an effect like fireworks, such as if an educator has an avatar in an XR environment and is suggesting “right on the nose” and is providing congratulations activity text display to a student user that has an avatar in the same XR environment.

In some embodiments, the XR system can detect facial expressions, such as changes in appearance or gestures of facial body parts to provide a control input and resulting action in response to the facial expression or gesture. For example, if a user points to their mouth in an XR environment, the user may also open or close their mouth, smile or frown, stick out their tongue, or provide other expressions and gestures that are recognized to provide different functionalities and actions in the XR environment. In one embodiment, and as another example, a user pointing at their mouth while covering their mouth with their other can trigger a “mute” function so that the user's audio communications may be muted as to one or other persons in the XR environment. Similarly, a user pointing to an ear and covering their ear with their hand may trigger a “mute” audio silencing function so that one or more audio sources in the XR environment are silenced, e.g., no volume, as to the user signaling such mute silencing input.

As previously described, when a user is not detected to be pointing at a body part or virtual object, the XR system does not trigger a functionality and remains in an “unactive” state. In related embodiments, a user might also point to a virtual object and attempt a command that is not compatible with the object being pointed at and the system will not present the functionality or may notify the user that such requested action or input is not understood and to try again. For example, if a user points at a virtual dog and says ‘show me a periodic table’ while a raycast intersect the virtual dog being pointed out, the XR system will determine incompatibility of the spoken command and the pointed at virtual object and the XR system can do nothing, can prompt the user for further information or to try again, ask the user if they would to replace the virtual dog with a periodic table, and like inquiries to clarify. However, if the user were pointing a virtual information board (e.g., virtual white board, chalkboard, projection screen and the like in an XR environment) which was detected by a raycast intersecting the virtual information board, the XR system will verify compatibility and display a periodic table on the compatible virtual object.

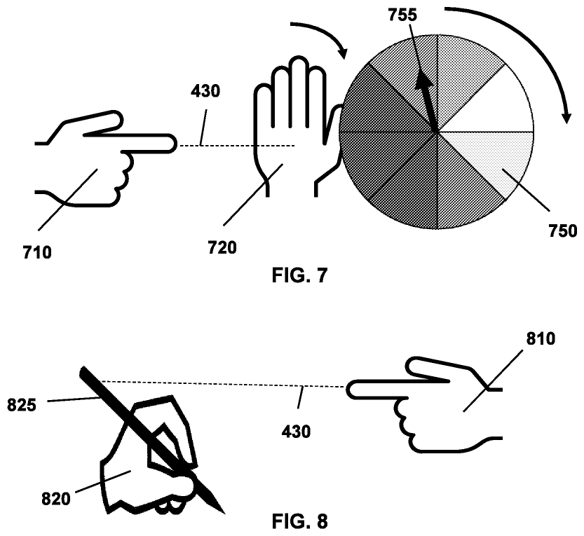

In other embodiments pointing at a user's mouth might bring up a language menu, volume control menu or other displayed functionalities and interactivities that depend on the XR environment, nearby virtual objects and/or the user's current activity in XR environment, i.e., the environmental context of the user's point and type of body part may result in different displayed results depending on such context. For example, referring to FIG. 7, a user might be nearby a virtual object that can have its color changed by the user (e.g., a virtual marker on a virtual desk of the user). The XR system can recognize the virtual proximity of the virtual marker to the user and pointing with one hand 710 to an open palm of the other hand 720 can be programmed as a signal or input for the user making a request to change the color of the nearby object (marker). The XR system will then display a color wheel menu 750 so that the user can select the color of the nearby object (marker). In the embodiment shown in FIG. 7, the user can rotate their hand to make a corresponding rotation of the color wheel 750 and then select the color with a selection indicator 755 that the nearby object should change to. It will be appreciated that the selection could be by stopping without further rotation at a color selection for a predetermined time interval, virtual pressing motion on a color, and the like. It will also be appreciated that similar menu display and attribute changes for nearby objects could take other display forms such as a dial, drop down menu, selection grid, flippable menu items, and the like.

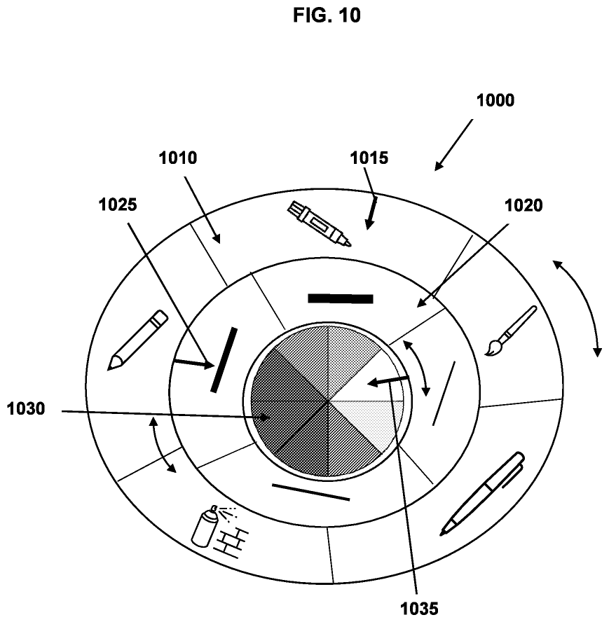

Referring to FIG. 9, and similar to the combination gesture shown in FIG. 3, in another embodiment a user can gesture for an item with one hand 910 providing a posed gesture and use the opposite hand 920 to specify an attribute about the item indicated with the first hand gesture. In this example, a user's first hand 910 provides a writing gesture to, for example, request a marker to use in an XR environment and the other opposite hand 920 indicates a palm up gesture for a complementary menu, such as a color wheel 950, dial, drop down menu and the like, to select and/or change a color for the requested virtual marker with a selection indicator 955. The first hand and second hand gestures indicate item for the XR system to display/provide the user (marker with first hand) and a simultaneous interactive menu for changing attribute or otherwise specifying additional feature of the item (color menu and interactive selection with second hand). In some embodiments, different gestures of the second hand can signal different menus for the corresponding item requested with the first hand. For example, a user could hold a palm face up with thumb extended as in FIG. 9 to request a color wheel for changing color of the requested virtual marker, but might alternatively curl the thumb inward on the second hand to create a different palm face gesture (thumb-in palm gesture). The thumb-in palm gesture could bring up a different menu such as for changing thickness of the virtual marker. Accordingly, one hand may provide a primary gesture indicating a “thing” that is requested or being acted on, and the second can may provide different gestures or poses to change or specify different attribute or features of that “thing” depending on the second gesture and associated menu.

In some embodiments, changes of appearance of a body part may include changing color, including of clothing on the body party, changing physical size, shape or other virtual body attributes that correspond to physical body part attributes, adding clothing or accessories (e.g., glasses added if pointing at eyes), and the like.

In embodiments of the invention, the XR system can provide visual feedback to the user that a pointing to the body part has been detected by changing the appearance of one or both of the first hand and body part. For example, if a user points with their right hand at their left arm, then the user's virtual left arm may change color, outlining, transparency, highlighting, glow level, shading and the like to visually confirm to the user that the XR system has detected that their right hand has been detected as pointing at their right arm and that a functionality is available or about to follow. When the user is not pointing at a body part, the change would not be activated, and the tracking state would be considered neutral with body appearance in a default and non-activated state (or unchanged state) until the body part is pointed at to activate the change of appearance and notification of the user. In further embodiments, a user may be provided a time interval before the functionality of the pointing action at the body part is triggered so that the user can point to different body parts and receive feedback by appearance changes of each body part being pointed at (e.g. arm might be pointed at and highlight or change color for a second, but the user wants to specify pointing at their mouth so they move their pointing hand until the mouth is highlighted for the required time interval to activate the corresponding functionality associated with a requested control input for the mouth-related functionality). In some embodiments the pointing hand might alternatively or also change in appearance to provide notification of the detection of the hand pointing at a body part.

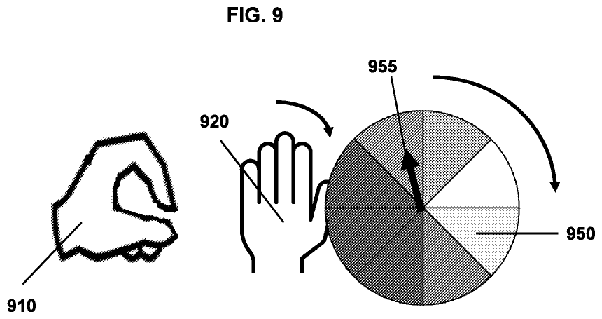

Referring to FIG. 8, in related embodiments a virtual object 825 can be held or worn by a user that may be pointed at and detected for control input. The XR system may receive a control input from a user in an XR environment by monitoring body movements of the user using an XR hardware display device to whom the XR environment is being displayed.

The XR system automatically detects when the user is pointing with a first hand 810 or a first virtual object in the extended reality environment being represented in the first hand to a second virtual object 825 in the extended reality environment that is being held in a second hand 820 or being worn by the user.

The XR system determines what the type of second virtual object being pointed to by the user is from among a plurality of different recognizable virtual objects through object database comparisons and/or AI processes. In some embodiments, a determination of the second object being pointed at could also be made by the type of object being programmed or saved in memory of the XR system so that when, for instance, raycasting is detected to intersect the second virtual object with the type of object having been programmed to be recognized where the virtual object is at such XR coordinates where the object is intersected.

Based on the type of second virtual object being pointed at in the extended reality environment at least one of a menu, a third virtual object, changed attribute of the second virtual object or an activity is displayed to the user.

As shown in FIG. 8, in one embodiment the second virtual object is a virtual writing instrument being held in the second hand of the user. For example, the type, writing thickness and color of the virtual writing instrument can be changed by the user following detecting of the pointing at the user. This change may be by a virtual menu displayed to the user, or in other embodiments could be by spoken input (such as the user saying “Blue Marker”) where the change occurs through the combination of pointing at the writing instrument, recognizing the user wants to do something to that instrument, and speech recognition provides input for changing the writing color the virtual marker to blue.

In further embodiments a virtual rotatable dial can displayed to the user, such as by pointing with one hand at virtual marker in the opposite hand to cause a rotatable dial of writing thicknesses to be displayed. The XR system can receive control input from the user to the dial to display at least one of the menu, the third virtual object, the changed attribute (such as a new writing thickness) of the second virtual object or the activity to the user.

Referring to FIG. 10, in some embodiments a virtual dial 1000 associated with a menu gesture from one hand can produce multiple hierarchical menus for specifying attributes about an item associated with a gesture of the opposite hand. For example, one hand making a gesture of writing instrument as an item with a first hand may generate display of a dial that can provide multiple levels of choices of attributes for the item requested. For example, as shown in FIG. 10, a multi-level concentric virtual dial 1000 or multiple concentric virtual dials can provide an outer rotatable dial 1010 with choice of type of writing instrument selectable with a selection indicator 1015, a next inner rotatable dial 1020 with choice of writing thickness selectable by selection indicator 1025 and a third innermost dial 1030 with choice of color selectable by selection indicator 1035. A user in the XR environment can move a hand and grab the respective dial or dial level to make a corresponding choice of that attribute for the item, such as a writing instrument. In some embodiments, a multi-level ideal might retract or only display multiple levels if interacted with by a user's hand (such as pressing the virtual dial to cause extension of the virtual dial levels or individual dials). It will be appreciated that rotation and movement selection indicators is only one embodiment for a user to choose different attributes from a hierarchal selection interface such as a virtual dial, and that a user could directly touch, point to, or use audible selections and the like to choose desired attributes displayed for selection.

### Hand Tracking Relative to Parts of Hand or Body Parts

In some embodiment of the invention, if you point to or touch certain parts of a hand or body part, different functionalities can be defined by the part touched. As an example, a user making a fist has five knuckles (4 finger knuckles and 1 thumb knuckle), and detecting touching or pointing at a knuckle can be programmed to trigger the system to provide different functions or events in the XR environment based on which knuckle is selected. It will be appreciated that the context of the user's interactivity and selection of knuckles based on the XR environment, nearby virtual objects, current, past or upcoming events, and the like may also determine what each knuckle, or other part of a body part, represents for functionality and interactive event options.

In some embodiments, a user's virtual hand might be color mapped or provided with a virtual glove wherein different parts of a user's hand will display with a different color. Depending on the color-coded portion of the user's hand that is selected by the user, such as by touching or pointing at a specified colored portion, a different gesture is determined, i.e., different functionality for each respective different colored portion of the hand.

### “Fish Ladder” Color Changing to Indicate Hand States and Activity Options

Embodiments of the invention use “fish ladder” color changing techniques to provide improved ways for a user to learn to use hand tracking in XR environments in color-coded steps, like a fish ladder—where fish jump over a dam by jumping step-by-step (“fish ladder”) until finally clearing the dam. It will be appreciated that users don't understand how to effectively use hand tracking from day one of entering an XR environment. Accordingly, to assist users in more quickly learning how to use and available functions of hand tracking, a system and method of the invention provides different colors to a user's hand to provide feedback and guidance on using the hand tracking capabilities. By default, a user's hand in an XR environment is usually displayed as a basic color such as gray, brown, and the like in embodiments of the system, a user's hand detected making a gesture will result in the hand changing color. that's a different color from the default had color. Similarly, when a user puts their hand on, in or over a virtual object or anything they can interact with in an XR environment, the XR system changes that hand to a different color, so the user knows they are intersecting or having interaction abilities with that object. As the user interacts with the virtual “something” different colors or gradients of colors can signify different information feedback and other available interactivity options to the user. For example, a hand can be changed to different colors to instruct the user that they can grab, open, close, pinch, lift, pull, rotate, climb or push the “something.” In some embodiments, the magnitude (such as applying pressure or force) if a user's activity can change to different colors or color gradients based on higher or lower magnitudes of the activity being applied.

In a preferred embodiment, an XR system of the invention will also provide feedback or similar notification to a user if the system loses track of a tracked hand or virtual object. Typically, when tracked objects or hands are lost from tracking in XR systems, the same revert to default colors, may disappear and/or are left in their last position in the XR environment while a person is still changing positions of their real-world hands without any reflection of the same in the XR environment. A visual, such as color change or highlighting (e.g., red color appearance of the “lost” tracked hand or object) or audible notification or text notification or the like, will be provided by the system to the user so that the user knows the XR system has lost a tracking capability and needs to find the same so that the user doesn't think their control inputs or movements are being followed and would produce results. It will be appreciated, as previously described, that color is not the only means for providing fish ladder feedback to a user, but other appearance features could change to provide feedback to a user regarding gesture detection and hands tracking, including outlining (such as outline thickness or dashed and dashed lines), transparency, highlighting, glow level, shading and the like.

As an example, for “fish ladder” colors in hand tracking the following can be utilized:
First color: default or basic color with no hand tracking by XR system
Second color: XR system is hand tracking
Third color: gesture is detected by XR system
Fourth color: XR system detects hand is in vicinity of virtual object, body part, or “something” that user can interact with
Fifth color: XR system notifies the user that they can grab, open, close, pinch, lift, pull, rotate, climb or push the “something.”
Sixth color: XR system confirms that user is/has interacting/interacted with the “something”

Accordingly, the different hierarchy of colors presented to user provide the series of command or actions to guide the user on hand tracking uses.

It should be understood from the foregoing that, while embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method for receiving a control input from a user in an extended reality environment comprising:
monitoring body movements of the user using an extended reality hardware display device to whom the extended reality environment is being displayed;
automatically detecting when the user is pointing with a first hand or a first virtual object in the extended reality environment being represented in the first hand to a second virtual object in the extended reality environment that is being held in a second hand or being worn by the user, wherein the virtual object is a virtual representation of a real world physical tool or article of clothing;
identifying a specific physical tool or article of clothing represented by the second virtual object being pointed at by the user from among different real world physical tools and articles of clothing; and
displaying in the extended reality environment at least one of a menu, a third virtual object, changed attribute of the second virtual object or an activity to the user based on the identifying of the specific physical tool or article clothing represented by the second virtual object being pointed at by the user.

2. The method of claim 1, wherein the second virtual object is a virtual writing instrument being held in the second hand of the user.

3. The method of claim 2, wherein one or more of the type, writing thickness and color of the virtual writing instrument is changed following detecting of the pointing.

4. The method of claim 2, further comprising receiving selection of one or more of the type, writing thickness and color of the virtual writing instrument by receiving one or more of audio input, detected gesture, and virtual menu selection from the user.

5. The method of claim 1, further comprising displaying a virtual rotatable dial to the user and receiving control input from the user to the dial to display at least one of the menu, the third virtual object, the changed attribute of the second virtual object or the activity to the user.

6. The method of claim 1, further comprising receiving a spoken input from the user and in response displaying at least one of the menu, the third virtual object, the changed attribute of the second virtual object or the activity to the user.

7. The method of claim 5, wherein the second virtual object is a virtual writing instrument being held in the second hand of the user.

8. The method of claim 7, wherein the control input indicates a writing thickness.

9. The method of claim 7, wherein the control input indicates a writing color.

10. The method of claim 1, further comprising displaying a menu that includes selectable types of the second virtual object being pointed to.

11. The method of claim 6, further comprising displaying a menu that includes selectable colors of the second virtual object being pointed to.

12. The method of claim 6, further comprising displaying a type of the second virtual object spoken by the user.

13. The method of claim 6, further comprising displaying the second virtual object as having a color spoken by the user.

14. The method of claim 12, further comprising displaying the second virtual object as having a color spoken by the user.

15. The method of claim 6, further comprising changing a displayed attribute of the second virtual object based on the spoken input from the user.

16. The method of claim 1, further comprising displaying a drop down menu and receiving control input from the user to the drop down menu to display at least one of the menu, the third virtual object, the changed attribute of the second virtual object or the activity to the user.

17. The method of claim 1, further comprising displaying a selection grid and receiving control input from the user to the selection grid to display at least one of the menu, the third virtual object, the changed attribute of the second virtual object or the activity to the user.

18. The method of claim 1, further comprising displaying a flippable menu and receiving control input from the user to the flippable menu to display at least one of the menu, the third virtual object, the changed attribute of the second virtual object or the activity to the user.
